(19) United States
(12) Patent Application Publication
(10) Pub. No.: US 2012/0098746 A1
(43) Pub. Date: Apr. 26, 2012

(54) Optical Position Detection Apparatus

(76) Inventor: Yasuji Ogawa, Ibaraki (JP)

(21) Appl. No.: 13/265,946

(22) PCT Filed: Apr. 19, 2010
(86) PCT No.: PCT/JP2010/002810

§ 371 Date: Nov. 17, 2011

Related U.S. Application Data
(60) Provisional application No. 61/172,139, filed on Apr. 23, 2009.

(30) Foreign Application Priority Data
Apr. 22, 2009 (JP) 2009-104577

(51) Int. Cl. G06F 3/033

(52) U.S. Cl. 345/158

(57) ABSTRACT

This invention is to provide an optical position detection apparatus including a retroreflective member (10) and a detection unit (20). The retroreflective member is disposed so as to cover the periphery of the detection area. The detection unit is disposed at one portion of the periphery of the detection area and detects a pointing position of the pointer by using reflection light reflected from the retroreflective member. The detection unit includes two detection sections (21) each having a light source section and camera section. The light source section has an irradiation angle wide enough to irradiate the entire detection area with light. The camera section includes a super-wide-angle lens and an image sensor, is disposed close to the light source section, and has a viewing angle wide enough to image the entire detection area. The two detection sections are arranged such that the distance therebetween is smaller than the wide of the detection area as viewed in the direction from the detection unit toward the detection area.

### TECHNICAL FIELD

The present invention relates to an optical position detection apparatus, and more particularly to an optical position detection apparatus that uses an image sensor to optically detect a position on a detection area pointed by a pointer.

### BACKGROUND ART

In recent years, there have been developed various optical position detection apparatuses and digitizers that use an image sensor. For example, Patent Document 1 filed by the present inventor discloses an optical digitizer having an image sensor which is arranged around a detection area so as to image a pointer, an imaging lens for imaging the pointer image on the image sensor, and a curved mirror for expanding the viewing angle of the image sensor. In this technique, curved mirrors are used in order to prevent a disadvantage that in the case where image sensors are disposed near the adjacent corners of a detection area, the image sensors are physically situated outside the detection area in the lateral direction. By the use of the curved mirrors, the image sensors and light sources can be disposed within the lateral dimension of the detection area.

### CITATION LIST

### Patent Literature

PLT1: Japanese Patent Application Kokai Publication No. 2001-142630

However, in the technique of Patent Document 1, the curved minors are still disposed near the adjacent corners of the detection area, so that there is a limitation on the installation position of the curved mirrors. Further, the arrangement positions of the curved minors, the image sensor, and the light sources need to be determined accurately, and it is difficult to install these components individually in an optional manner. Further, when the position detection function is applied to a blackboard or whiteboard to construct a digitizer, it is difficult to install such curved mirrors that can cover an enormously large detection area. Further, it can be considered that the pair of curved minors and the pair of image sensors are integrated into a unit for fixation of the relative position between them so as to facilitate their positioning. In this case, however, the unit size is correspondingly increased so that the unit covers the entire side of the detection area, so that in the case where the detection area is enormously large, the size of the entire apparatus is increased.

Further, in Patent Document 1, a half mirror, etc., is used to make the optical axes of the light source and the image sensor coincide with each other, so that the amount of light attenuates, resulting in low efficiency. Further, it is difficult to make the optical axes of the respective components, including the curved mirrors, coincide with one another.

### SUMMARY OF INVENTION

### Technical Problem

In view of the above situation, an object of the present invention is to provide an optical position detection apparatus having a compact detection unit and capable of being easily detached and attached.

To achieve the above object of the present invention, according to a first aspect of the present invention, there is provided an optical position detection apparatus comprising: a retroreflective member that is provided on a pointer or disposed so as to cover at least a part of the periphery of a detection area; and a detection unit that is disposed at one portion of the periphery of the detection area and detects a pointing position of the pointer by using reflection light reflected from the retroreflective member, the unit including at least two detection sections each having a light source section that emits light traveling along a surface direction of the detection area and a camera section that images light emitted from the light source section and reflected by the retroreflective member. The light source section has an irradiation angle wide enough to irradiate the entire detection area with light. The camera section includes a super-wide-angle lens and an image sensor, is disposed close to the light source section, and has a viewing angle wide enough to image the entire detection area. The two detection sections are arranged such that the distance therebetween is smaller than a width of the detection area as viewed in the direction from the detection unit toward the detection area.

The light source section may include a toric lens and a plurality of LEDs.

The super-wide-angle lens and/or the toric lens may be molded from a lens resin.

The super-wide-angle lens may be formed into a thin shape lens having the upper and lower planar surfaces extending along the surface direction of the detection area and stacked with the light source section.

The detection unit may include three detection sections, which are disposed such that the distance between two detection sections of the three at both sides is smaller than the width of the detection area as viewed in the direction from the detection unit toward the detection area and the remaining one detection section is disposed between the two detection sections.

The detection unit may be detachably attached to one portion of the periphery of the detection area.

The retroreflective member that is disposed so as to cover at least a part of the periphery of the detection area may be detachably attached to the periphery of the detection area.

The detection unit and/or the retroreflective member may have a magnet for detachable attachment to the periphery of the detection area.

The optical position detection apparatus may further comprise, in the periphery of the detection area, a positioning base member made of a ferromagnetic material to which the magnet provided in the detection unit and/or the retroreflective member can be adhered.

The detection unit may simultaneously detect pointing positions of a plurality of pointers.

According to a second aspect of the present invention, there is provided an optical position detection apparatus comprising: a pointer having, at its tip portion, a light source; and a detection unit that is disposed at one portion of the periphery of a detection area and detects a pointing position of the pointer by using light emitted from the light source of the pointer, the unit including at least two camera sections that image light emitted from the light source of the pointer. Each of the camera sections includes a super-wide-angle lens and an image sensor and has a viewing angle wide enough to image the entire detection area. The two camera sections are arranged such that the distance therebetween is smaller than the width of the detection area as viewed in the direction from the detection unit toward the detection area.

According to a third aspect of the present invention, there is provided an optical position detection apparatus including: a detection unit that is disposed at one portion of the periphery of a detection area and detects a pointing position of a pointer, the unit including a light source section that emits light traveling along the surface direction of the detection area and at least two camera sections that image light emitted from the light source section and reflected by the pointer. Each of the camera sections includes a super-wide-angle lens and an image sensor and has a viewing angle wide enough to image the entire detection area. The light source section is disposed between the at least two camera sections and has an irradiation angle wide enough to irradiate the entire detection area with light. The two camera sections are arranged such that the distance therebetween is smaller than the width of the detection area as viewed in the direction from the detection unit toward the detection area.

The light source section may include a plurality of infrared LEDs, and each of the camera sections may include an infrared ray transmission filter and perform an imaging operation only during emission of light from the light source section.

### Advantageous Effects of Invention

The optical position detection apparatus of the present invention has advantages that the detection unit is configured in a compact shape and detaching and attaching of the optical position detection apparatus can easily be performed.

### BRIEF DESCRIPTION OF DRAWINGS

FIG. 1 is a schematic configuration view for explaining an optical position detection apparatus according to a first embodiment of the present invention.

FIG. 2 is a perspective view for explaining a configuration of a detection unit of the optical position detection apparatus according to the first embodiment of the present invention.

FIG. 3 is a view for explaining a configuration of a light source section used in the optical position detection apparatus according to the first embodiment of the present invention.

FIG. 4 is a view for explaining a configuration of a camera section used in the optical position detection apparatus according to the first embodiment of the present invention.

FIG. 5 is a schematic configuration view for explaining an optical position detection apparatus according to a second embodiment of the present invention.

FIG. 6 is a schematic configuration view for explaining an optical position detection apparatus according to a third embodiment of the present invention.

FIG. 7 is a schematic configuration view for explaining an optical position detection apparatus according to a fourth embodiment of the present invention.

### DESCRIPTION OF EMBODIMENTS

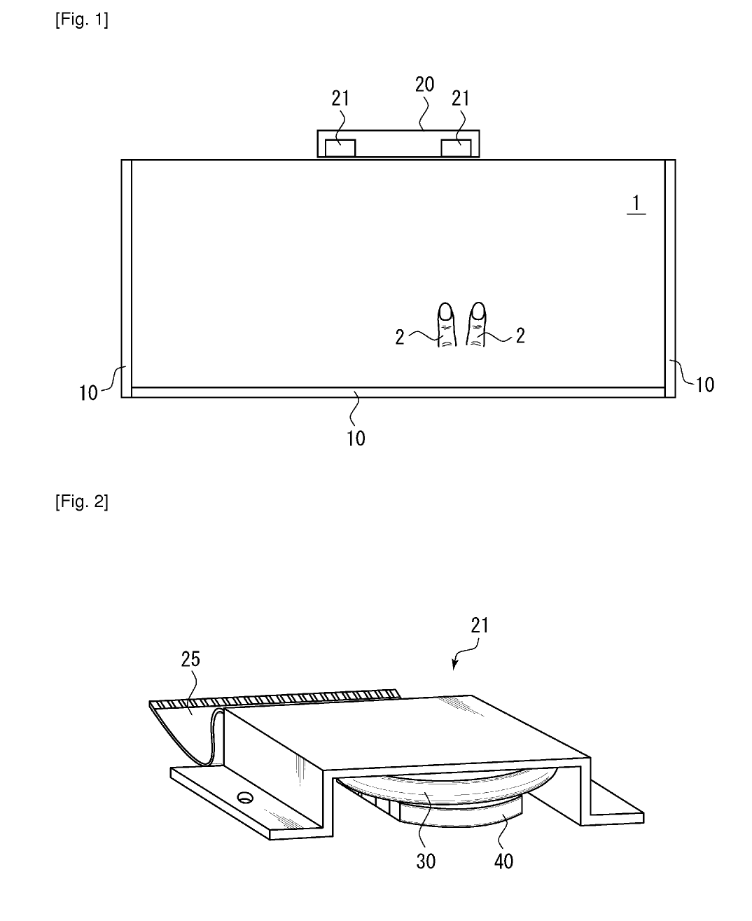

Embodiments for practicing the present invention will be described below with reference to the accompanying drawings. FIG. 1 is a schematic configuration view for explaining an optical position detection apparatus according to a first embodiment of the present invention. The first embodiment is an example in which a position pointed by a pointer, such as a finger or a pointing bar, that itself does not have a special function is detected. As shown in FIG. 1, the optical position detection apparatus that can detect a pointing position of a pointer 2 on a detection area 1 is mainly constituted by a retroreflective member 10 and a detection unit 20.

The retroreflective member 10 is disposed so as to cover at least a part of the detection area 1. More specifically, the retroreflective member 10 is disposed so as to cover the three sides around the detection area 1.

The detection unit 20 is disposed at one portion of the periphery of the detection area 1. More specifically, the detection unit 20 is disposed on one side of the detection area 1 on which the retroreflective member 10 is not disposed. The detection unit 20 detects a pointing position of the pointer 2 by using reflection light from the retroreflective member 10. The detection unit 20 shown in FIG. 1 includes two detection sections 21. The two detection sections 21 are arranged such that the distance therebetween is smaller than the width of the detection area 1 as viewed in the direction from the detection unit 20 toward the detection area. More specifically, the two detection sections 21 are arranged inside the both vertical sides of the detection area 1 so that, on the drawing of FIG. 1, the distance between the two detection sections 21 is smaller than the length of the upper lateral side of the detection area 1. As described later, the optical position detection apparatus of the present invention is configured to detect a pointing position of the pointer using the principle of triangulation, so that the distance between the two detection sections 21 influences the detection accuracy, and the smaller the distance between the two detection sections 21, the worse the detection accuracy. Therefore, the two detection sections 21 may be arranged such that the interval therebetween is, e.g., about ½ of the length of the upper lateral side of the detection area 1 while the detection accuracy is maintained at an acceptable level. The distance between the two detection sections may be made smaller as long as the detection accuracy is in an acceptable range. Thus, the lateral length of the detection unit can be made shorter, so that the entire detection unit can be configured in a compact shape.

FIG. 2 is a perspective view for explaining a configuration of a detection section of the detection unit of the optical position detection apparatus according to the first embodiment of the present invention. In FIG. 2, the same reference numerals as those in FIG. 1 denote the same parts as those in FIG. 1. As shown in FIG. 2, the detection section 21 mainly includes a light source section 30 and a camera section 40.

The light source section 30 is configured to have such an irradiation angle that the entire detection area 1 (see FIG. 1) can be irradiated with light. That is, the light source section 30 is configured to have an irradiation angle that covers the entire detection area 1 in the surface direction. The light source section 30 achieves an irradiation angle of about 120 degrees to 180 degrees by using, e.g., a plurality of LEDs (Light Emitting Diodes) arranged in a fan-shape.

The camera section 40 images light emitted from the light source section 30 and reflected by the retroreflective member 10 (see FIG. 1). The camera section 40 includes a super-wide-angle lens and an image sensor, is disposed close to the light source section 30, and has a viewing angle wide enough to image the entire detection area 1. That is, the camera section 40 is configured to have a viewing angle that covers the entire detection area 1 in the surface direction. The camera section 40 achieves a viewing angle of about 120 degrees to 180 degrees by using the super-wide-angle lens. In the present invention, the super-wide-angle lens of the camera section includes a fish-eye lens that does not correct distortion. The distortion need not always be corrected on the lens side and, in the case where the distortion is not corrected on the lens side, the image sensor is used to correct imaged data as needed.

It is desirable that the closer the detection unit having the detection section including the light source section 30 and the camera section 40 is disposed relative to the detection area 1, the wider the irradiation angle of the light source section 30 and the viewing angle of the camera section 40 are so as to cover the entire detection area 1.

The above-configured detection sections 21 each have a flexible substrate 25 which is connected to a controller or a computer (not shown) provided inside or outside the detection unit. The detection unit and the controller or the like may be connected to each other by a wired connection using a USB (Universal Serial Bus) or by a wireless connection using Bluetooth (Registered Trademark).

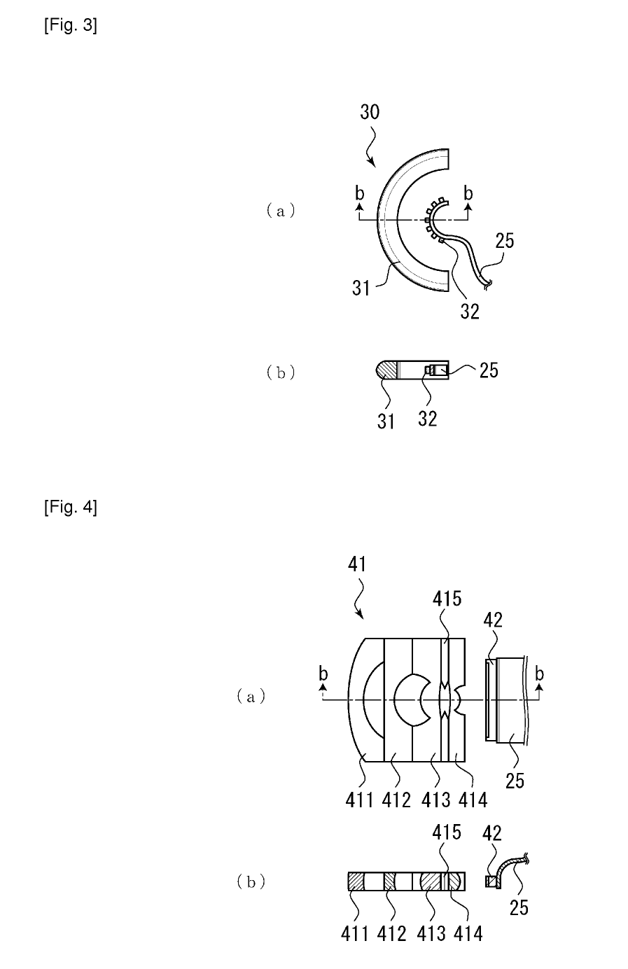

A specific configuration of the light source section 30 will be described below with reference to FIG. 3. FIG. 3 is a view for explaining a configuration of the light source section used in the optical position detection apparatus according to the first embodiment of the present invention. FIG. 3(a) is a top view of the light source section and FIG. 3(b) is a cross-sectional view taken along b-b line. In FIG. 3, the same reference numerals as those in FIG. 2 denote the same parts as those in FIG. 2. As shown, the light source section 30 includes, e.g., a toric lens 31 and a plurality of LEDs 32.

As shown in FIG. 3, the toric lens 31 is a lens having a refractive surface of a shape obtained by curving a cylindrical lens which is a plane-convex lens having a cylindrical refractive surface. The toric lens 31 is configured to radiate light from the LEDs 32 with a radiation angle of at least 120 degrees in the horizontal direction and condense the light in the vertical direction. That is, the toric lens 31 can radiate light parallel to the surface of the detection area 1 and having a wide radiation pattern with respect to the surface direction of the detection area 1. The refractive surface or curvature of the toric lens 31 may be set such that light radiated from the toric lens 31 travels along the surface direction of the detection area 1 and the light is uniformly irradiated over the entire detection area 1. Further, the toric lens 31 may be made of, e.g., a lens resin. The lens resin is a resin such as plastic, acrylic, or polycarbonate. When a lens is molded from the lens resin, it is possible to eliminate the need of applying polishing processing, resulting in a reduction in manufacturing cost of the lens.

The plurality of LEDs 32 are arranged in a fan-shape as shown in FIG. 3(a) and emit light traveling along the surface direction of the detection area 1 via the toric lens 31. For example, the LEDs 32 may be infrared LEDs. Further, the LEDs 32 may be directly provided on the flexible substrate 25.

The light source section used in the optical position detection apparatus of the present invention is not limited to the example shown in the drawings but may have any configuration as long as the light source section has an irradiation angle wide enough to irradiate the entire detection area with light. For example, a configuration may be adopted in which several LEDs each having a wide irradiation angle are used to emit light that covers the entire detection area in the surface direction.

Next, a specific configuration of the camera section 40 will be described with reference to FIG. 4. FIG. 4 is a view for explaining a configuration of the camera section used in the optical position detection apparatus according to the first embodiment of the present invention. FIG. 4(a) is a top view of the camera section, and FIG. 4(b) is a cross-sectional view taken along b-b line. In FIG. 4, the same reference numerals as those in FIG. 2 denote the same or corresponding parts as those in FIG. 2. As shown, the camera section 40 includes, e.g., a super-wide-angle lens 41 and an image sensor 42.

As shown in FIG. 4, the super-wide-angle lens 41 is composed of, for example, 2-group 4-element lenses. More specifically, the super-wide-angle lens 41 includes a first lens 411, a second lens 412, a third lens 413, and a fourth lens 414 arranged in this order from the detection area toward the imaging surface of the image sensor 42. An aperture 415 is provided between the third and fourth lenses 413 and 414. The first lens 411 is a negative meniscus lens having a convex surface facing the detection area side, the second lens 412 is a negative lens having a small curvature surface facing the imaging surface side, the third lens 413 is a positive lens having a convex surface facing the detection area side, and the fourth lens 414 is a positive lens having a convex surface facing the imaging surface side.

The above lenses are formed into a thin sliced lens group having the upper and lower surfaces extending along the surface direction of the detection area 1. Then, this super-wide-angle lens 41 is stacked with the light source section 30 as shown in FIG. 2. More specifically, the super-wide-angle lens 41 and the toric lens 31 are vertically arranged. This configuration allows a reduction in the thickness of the detection section 21 and allows the optical axes of the light source section 30 and the camera section 40 to be brought close to each other.

Further, the super-wide-angle lens 41 may be made of, e.g., a lens resin. When a lens is molded from the lens resin, it is possible to eliminate the need of applying polishing processing, resulting in a reduction in manufacturing cost of the lens.

The image sensor 42 is a solid-state image sensing device such as a CCD or a CMOS. The image sensor 42 only needs to be a linear image sensor or an area image sensor. In the case where the image sensor 42 is an area image sensor, the image sensor 42 can detect the motion of the pointer before and after touch detection by the position detection apparatus in the height detection, so that high-level detection can be achieved. The image sensor 42 may directly be disposed on the flexible substrate 25. The flexible substrate 25 of the light source section 30 shown in FIG. 3 and the flexible substrate 25 of the camera section 40 shown in FIG. 4 may be formed by a single common substrate.

The camera section used in the optical position detection apparatus of the present invention is not limited to the example shown in the drawings but may have any configuration as long as the camera section has a lens configuration having a viewing angle wide enough to image the entire detection area 1. For example, any lens configuration may be employed as long as the entire detection area in the surface direction can be covered by the viewing angle. Further, a fish-eye lens that does not correct distortion may be used, and the viewing angle may exceed 180 degrees.

The optical position detection apparatus according to the first embodiment of the present invention is constituted by the detection unit and the retroreflective member having the configurations as described above. The detection unit and the retroreflective member may be detachably attached to the periphery of the detection area. For example, in the case where the optical position detection apparatus of the present invention is used with a blackboard or whiteboard as a digitizer, the detection unit is attached to one portion, e.g., upper lateral side of the periphery of the blackboard as the detection area, and the retroreflective member is attached to cover the periphery, e.g., both vertical sides and the lower lateral side of the blackboard as shown in FIG. 1. The detection unit and the retroreflective member may each have a magnet on the rear surface serving as the attaching surface for attachment/detachment to/from the periphery of the detection area. The use of the magnet makes it easy to attach the detection unit and the retroreflective member to the blackboard or white board.

Further, in the case where the optical position detection apparatus of the present invention is used with a liquid crystal display device or plasma display device as a touch panel, a positioning base member made of a ferromagnetic material to which a magnet can be adhered may be attached to the bezel of the display area using a doublefaced tape. The positioning base member preferably has, e.g., a concave portion to which the magnet provided in the detection unit or retroreflective member is fit so as to facilitate the positioning of the detection unit or the retroreflective member. As the positioning base member, one having a frame shape like the bezel may be used. In this case, the installation position of the detection unit or the retroreflective member are previously determined, so that arrangement of the detection unit or the retroreflective member can be facilitated. Further, in place of the frame-like positioning base member, a plate-like positioning base member provided in a portion corresponding to the position of the magnet of the detection unit or retroreflective member may be used. Also in this case, by allowing the magnet to be fit to the concave portion formed in the positioning base member, the detection unit and the retroreflective member can easily be arranged.

Calibration of a detected position in the detection area may be performed after the installation of the detection unit and the retroreflective member as an adjustment process for detection of an accurate pointing position.

Next, processing of detecting a pointing position of a pointer performed by using the above-configured optical position detection apparatus according to the first embodiment of the present invention will be described. The first embodiment of the present invention has a configuration for detecting a pointing position of a pointer, such as a finger or a pointing bar, that itself does not have a special function. In the present embodiment, light emitted from the light source section 30 of the detection section 21 is reflected by the retroreflective member 10, and the reflected light that retroreflected and return to the initial position is imaged by the camera section 40. In the present invention, the light source section 30 has an irradiation angle wide enough to irradiate the entire detection area with light and the super-wide-angle lens has a viewing angle wide enough to image the entire detection area, so that the images of all the retroreflective members 10 provided on the three sides of the detection area are captured on the camera section 40 of each detection section 21. In the case where the pointer 2 such as a finger is input to the detection area 1, reflection light from the retroreflective member 10 is interrupted by the pointer 2 with the result that the image corresponding to shadow is detected by each detection section 21. Based on the principle of triangulation using the positions of the shadows detected by the two detection sections 21 and the distance between the two detection sections 21, the pointing position (two-dimensional coordinate) of the pointer can be calculated. This calculation may be performed by a computer provided inside or outside the detection unit 20.

Further, in the optical position detection apparatus according to the first embodiment of the present invention, the image sensor can detect the positions of a plurality of shadows, which allows simultaneous detection of pointing positions of a plurality of pointers. That is, so called multi-touch detection can be realized in the position detection apparatus.

In the optical position detection apparatus of the present invention, the two detection sections can be disposed close to each other such that the distance between the two detection sections is smaller than the width of the detection area, resulting in an advantage for the multi-touch detection. That is, in the case of the present invention where the two detection sections are disposed close to each other in the vicinity of the center portion of the detection area, when two pointers are input to the left and right portions of the detection area, each detection section can detect one pointer with less interference from the other pointer. On the other hand, in the case where the detection sections are disposed near both corners of the detection area, as in the prior art, a pointer input to, e.g., the left side interrupts the view of the detection section at the left side corner, so that it is more likely that a pointer input to the right side enters the blind spot of the pointer input to the left side. As is clear from the above comparison, it can be understood that the optical position detection apparatus of the present invention is advantageous in the multi-touch detection.

Although the detection unit 20 includes two detection sections 21 in the above description, the present invention is not limited to this but the detection unit 20 may include three detection sections. In this case, the three detection sections may be disposed such that the distance between two detection sections of the three at both sides is smaller than the width of the detection area as viewed in the direction from the detection unit toward the detection area and the remaining one detection section is disposed between the two detection sections. Particularly, in the case where a configuration in which pointing positions of a plurality of pointers can be detected is adopted, it is possible to reduce the blind spot caused by a pointer input to a position in front of a given detection section. The number of the detection sections may be increased to four or more.

As described above, according to the present invention, there is provided an optical position detection apparatus having a compact detection unit and capable of being easily detached and attached. Further, restriction on the arrangement position of the detection sections is small, so that it is possible to increase the number of the detection sections so as to reduce false recognition.

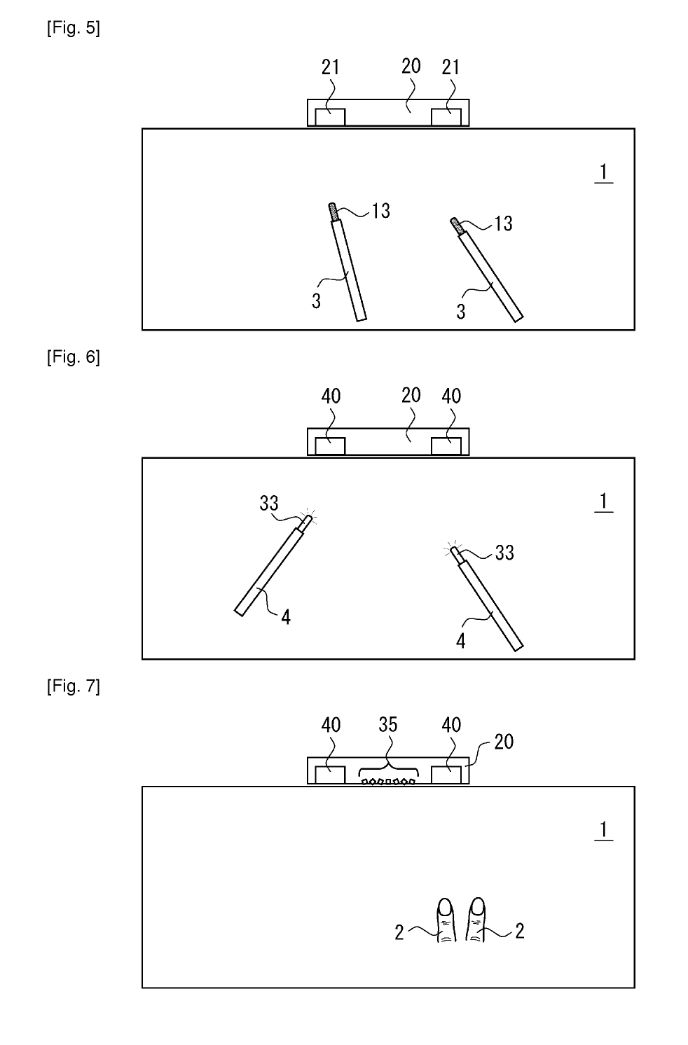

Next, an optical position detection apparatus according to a second embodiment of the present invention will be described with reference to FIG. 5. FIG. 5 is a schematic configuration view for explaining an optical position detection apparatus according to the second embodiment of the present invention. The second embodiment is a case where the pointer has the retroreflective member. In FIG. 5, the same reference numerals as those in FIG. 1 denote the same parts as those in FIG. 1. As shown in FIG. 5, a pointer 3 to be input to the detection area 1 has at its tip portion a retroreflective member 13, while the retroreflective member covering the three sides of the detection area, which is used in the first embodiment, is not provided. Other configurations are the same as those of the first embodiment, and the descriptions thereof will be omitted.

Processing of detecting a pointing position of a pointer performed by using the above-configured optical position detection apparatus according to the second embodiment will be described. In the case where the pointer 3 is not input to the detection area 1, nothing is detected by the camera section 40 of the detection section 21. When the pointer 3 is input to the detection area 1, light emitted from the light source section 30 of the detection section 21 is reflected by the retroreflective member 13 provided at the tip portion of the pointer 3, and the retroreflected light is imaged by the camera section 40. Thus, based on the principle of triangulation using the positions of the reflection lights detected by the two detection sections 21 and the distance between the two detection sections 21, the pointing position (two-dimensional coordinate) of the pointer can be calculated.

Since there is provided no frame member, such as the retroreflective member, that surrounds the detection area in the optical position detection apparatus of the second embodiment, the detection area need not be formed in a rectangular shape but an area having a distance over which the camera section can detect the pointer may be set as the detection area.

Further, in the case where ambient light and reflection light are indistinguishable from each other, there is a possibility that the pointer is falsely recognized due to absence of the frame member surrounding the detection area. To prevent this, e.g., non-reflective frame member is used to surround the periphery of the detection area so as to block the ambient light. Alternatively, a configuration may be adopted in which the light source section is made to emit pulse light, and filtering is appropriately performed so as to detect only reflection light corresponding to the pulse light. Further alternatively, a configuration may be adopted in which infrared LED are used as the LEDs of the light source section, an infrared ray transmission filter is provided in the camera section, and the imaging operation is performed only during emission of light from the light source section.

Other configurations, applications and effects are the same as those of the first embodiment, and the descriptions thereof will be omitted.

Next, an optical position detection apparatus according to a third embodiment of the present invention will be described with reference to FIG. 6. FIG. 6 is a schematic configuration view for explaining an optical position detection apparatus according to the third embodiment of the present invention. The third embodiment is a case where the pointer has a light source. In FIG. 6, the same reference numerals as those in FIGS. 1 and 2 denote the same parts as those in FIGS. 1 and 2. As shown in FIG. 6, a pointer 4 to be input to the detection area 1 has at its tip portion a light source 33 such as an LED, while the retroreflective member covering the three sides of the detection area, which is used in the first embodiment, or the retroreflective member at the tip portion of the pointer, which is used in the second embodiment, is not provided.

Further, the detection unit 20 has at least two camera sections 40 that images light emitted from the light source 33 of the pointer 4. That is, the camera section and the light source section are integrally stacked with constitute the detection section in the first and second embodiments, while in the third embodiment, only the camera section is provided in the detection unit.

Processing of detecting a pointing position of a pointer performed by using the above-configured optical position detection apparatus according to the third embodiment will be described. In the case where the pointer 4 is not input to the detection area 1, nothing is imaged by the camera section 40 of the detection unit 20. When the pointer 4 is input to the detection area 1, light emitted from the light source 33 provided at the tip portion of the pointer 4 is imaged by each camera section 40. Thus, based on the principle of triangulation using the positions of the lights detected by the two camera sections 40 and the distance between the two camera sections 40, the pointing position (two-dimensional coordinate) of the pointer can be calculated.

There is provided no frame member that surrounds the detection area also in the optical position detection apparatus of the third embodiment, so that in the case where ambient light and reflection light are indistinguishable from each other, there is a possibility that the pointer is falsely recognized. To prevent this, e.g., non-reflective wall member may be used to surround the periphery of the detection area. Alternatively, a configuration may be adopted in which the light source provided at the tip portion of the pointer is made to emit pulse light, and filtering is appropriately performed so as to detect only light corresponding to the pulse light. Further alternatively, a configuration may be adopted in which an infrared LED is used as the LED of the light source provided at the tip portion of the pointer, an infrared ray transmission filter is provided in the camera section, and the imaging operation is performed only during emission of light from the infrared LED.

Other configurations, applications and effects are the same as those of the first and second embodiments, and the descriptions thereof will be omitted.

Next, an optical position detection apparatus according to a fourth embodiment of the present invention will be described with reference to FIG. 7. FIG. 7 is a schematic configuration view for explaining an optical position detection apparatus according to the fourth embodiment of the present invention. The fourth embodiment is a case where the image of a pointer, such as a finger or a pointing bar, that itself does not have a special function is directly imaged to detect a position pointed by the pointer. In FIG. 7, the same reference numerals as those in FIG. 6 denote the same parts as those in FIG. 6.

As shown in FIG. 7, the pointer 2 is a finger or the like. The detection unit 20 has at least two camera sections 40. A light source section 35 is disposed between the two camera sections and is configured to have an irradiation angle wide enough to irradiate the entire detection area 1 with light. The light source section 35 is constituted by, e.g., a plurality of infrared LED which are arranged so as to spread in a radial fashion. The light source section 35 may have a configuration in which the plurality of infrared LEDs each inclined at predetermined angles so as to allow the light from the LEDs to spread radially are linearly arranged as shown in FIG. 7 or in which the plurality of infrared LEDs are arranged in a fan-shape. Further, a scattering plate may be disposed in front of the LEDs so as to make the light from the LEDs uniform. For example, a lenticular lens may be used as the scattering plate so as to make smooth light broadly irradiated in the surface direction of the detection area.

Further, in the optical position detection apparatus of the fourth embodiment, the camera section directly images the image of the pointer, so that, for example, a configuration may be adopted in which the light source section 35 is made to emit strong light at extremely short time intervals, and the imaging operation is performed during the emission. The emission amount of the light source section may be determined based on the shutter speed, the aperture of the camera section and the standard luminance of the detection area. A configuration may be adopted in which a plurality of infrared LEDs are used as the LEDs of the light source section, an infrared ray transmission filter is provided in front of the lens of the camera section or in front of the image sensor, and the imaging operation is performed only during emission of infrared light from the light source section. In this case, it is possible to reduce influence of ambient light.

Processing of detecting a pointing position of a pointer performed by using the above-configured optical position detection apparatus according to the fourth embodiment will be described. In the case where the pointer 2 is not input to the detection area 1, nothing is imaged by the camera section 40 of the detection unit 20. When the pointer 2 is input to the detection area 1, the pointer 2 is irradiated with light emitted from the light source section 35, and the image of the pointer 2 is imaged by each camera section 40 as reflection light. Thus, based on the principle of triangulation using the positions of the images of the pointers 2 detected by the two camera sections 40 and the distance between the two camera sections 40, the pointing position (two-dimensional coordinate) of the pointer can be calculated.

Other configurations, applications and effects are the same as those of the first to third embodiments, and the descriptions thereof will be omitted.

The optical position detection apparatus of the present invention is not limited to the above illustrative examples but may be variously modified without departing from the scope of the present invention.

1. An optical position detection apparatus capable of detecting a pointing position of a pointer to be input to a detection area, the apparatus comprising:
a retroreflective member that is provided on the pointer or disposed so as to cover at least a part of the periphery of the detection area; and
a detection unit that is disposed at one portion of the periphery of the detection area and detects a pointing position of the pointer by using reflection light reflected from the retroreflective member, the detection unit including at least two detection sections each having a light source section that emits light traveling along a surface direction of the detection area and a camera section that images light emitted from the light source section and reflected by the retroreflective member, wherein the light source section has an irradiation angle wide enough to irradiate the entire detection area with light, the camera section includes a super-wide-angle lens and an image sensor, being disposed close to the light source section, and has a viewing angle wide enough to image the entire detection area, and the two detection sections are arranged such that the distance therebetween is smaller than a width of the detection area as viewed in the direction from the detection unit toward the detection area.

2. The optical position detection apparatus according to claim 1, wherein the light source section includes a toric lens and a plurality of LEDs.

3. The optical position detection apparatus according to claim 2, wherein the super-wide-angle lens and/or the toric lens are molded from a lens resin.

4. The optical position detection apparatus according to claim 1, wherein the super-wide-angle lens is formed into a thin shape lens having the upper and lower planar surfaces extending along the surface direction of the detection area and stacked with the light source section.

5. The optical position detection apparatus according to claim 1, wherein the detection unit includes three detection sections, which are disposed such that the distance between two detection sections of the three at both sides is smaller than the width of the detection area as viewed in the direction from the detection unit toward the detection area and the remaining one detection section is disposed between the two detection sections.

6. The optical position detection apparatus according to claim 1, wherein the detection unit is detachably attached to one portion of the periphery of the detection area.

7. The optical position detection apparatus according to claim 1, wherein the retroreflective member that is disposed so as to cover at least a part of the periphery of the detection area is detachably attached to the periphery of the detection area.

8. The optical position detection apparatus according to claim 7, wherein the detection unit and/or the retroreflective member have a magnet for detachable attachment to the periphery of the detection area.

9. The optical position detection apparatus according to claim 8, further comprising, in the periphery of the detection area, a positioning base member made of a ferromagnetic material to which the magnet provided in the detection unit and/or the retroreflective member can be adhered.

10. The optical position detection apparatus according to claim 1, wherein the detection unit simultaneously detects pointing positions of a plurality of pointers.

11. An optical position detection apparatus capable of detecting a pointing position pointed on a detection area, the apparatus comprising:
a pointer having, at its tip portion, a light source; and
a detection unit that is disposed at one portion of the periphery of the detection area and detects a pointing position of the pointer by using light emitted from the light source of the pointer, the unit including at least two camera sections that image light emitted from the light source of the pointer, wherein each of the camera sections includes a super-wide-angle lens and an image sensor and has a viewing angle wide enough to image the entire detection area, and the two camera sections are arranged such that the distance therebetween is smaller than the width of the detection area as viewed in the direction from the detection unit toward the detection area.

12. An optical position detection apparatus capable of detecting a pointing position of a pointer to be input to a detection area, the apparatus comprising:
a detection unit that is disposed at one portion of the periphery of the detection area and detects a pointing position of the pointer, the unit including a light source section that emits light traveling along the surface direction of the detection area and at least two camera sections that image light emitted from the light source section and reflected by the pointer, each of the camera sections including a super-wide-angle lens and an image sensor and having a viewing angle wide enough to image the entire detection area, the light source section being disposed between the at least two camera sections and having an irradiation angle wide enough to irradiate the entire detection area with light, and the two camera sections being arranged such that the distance therebetween is smaller than the width of the detection area as viewed in the direction from the detection unit toward the detection area.

13. The optical position detection apparatus according to claim 12, wherein the light source section includes a plurality of LEDs, and each of the camera sections includes an infrared ray transmission filter and performs the imaging operation only during emission of light from the light source section.
